(19) United States
(12) Patent Application Publication
(10) Pub. No.: US 2020/0358238 A1
(43) Pub. Date: Nov. 12, 2020

(54) Terminal Extraction Jig

(71) Applicant: Yazaki Corporation, Tokyo (JP)

(72) Inventors: Tomoyuki Miyakawa, Utsunomiya-shi (JP); Masaki Tanaka, Utsunomiya-shi (JP)

(73) Assignee: Yazaki Corporation, Tokyo (JP)

(21) Appl. No.: 16/844,127

(22) Filed: Apr. 9, 2020

(30) Foreign Application Priority Data
May 10, 2019 (JP) 2019-089870

(51) Int. Cl. H01R 43/20

(52) U.S. Cl. CPC H01R 43/20

(57) ABSTRACT

The present invention provides a terminal extraction jig configured to release a locking state of a female terminal caused by a lance configured to lock the female terminal accommodated in a terminal accommodation chamber of a housing. The terminal extraction jig includes: a release pin configured to be inserted into the housing, abut against a locking release piece of the lance, and cause the locking release piece to displace in a locking release direction opposite to a locking direction of the female terminal; and a guide pin that is provided below and in parallel with the release pin, and is configured to guide the release pin to the locking release piece of the lance by being inserted into a fitting groove formed in the housing.

### CROSS REFERENCE TO RELATED APPLICATIONS

This application is based on and claims priority from Japanese patent application No. 2019-089870 filed on May 10, 2019, the entire contents of which are incorporated herein by reference.

### BACKGROUND OF THE INVENTION

### 1. Technical Field

The present invention relates to a terminal extraction jig.

### 2. Background Art

In a connector in which a terminal crimped and connected to an end portion of an electrical wire is accommodated in a terminal accommodation chamber of a housing, a problem such as insufficient crimping with the electrical wire may occur. In this case, the terminal may be removed from the terminal accommodation chamber of the housing and replaced with a new terminal.

To remove the terminal from the terminal accommodation chamber of the housing, a release pin of a terminal extraction jig is inserted into the housing, and a locking portion that locks the terminal is displaced by a tip end of the release pin, so as to release locking of the terminal (see, for example, Patent Literature JP-A-2005-216660).

### SUMMARY

However, when the terminal extraction jig is inclined relative to the housing at the time of releasing the locking of the terminal caused by the locking portion, the release pin may be inserted obliquely and the locking portion may be damaged or deformed by the tip end portion of the release pin.

The present invention has been made in view of the above circumstances, and an object thereof is to provide a terminal extraction jig capable of smoothly and easily removing a terminal from a housing without damaging a locking portion or the like that locks the terminal.

In order to achieve the above object, the terminal extraction jig according to the present invention is characterized by the following (1) to (4).

(1) A terminal extraction jig configured to release a locking state of a terminal caused by a locking portion configured to lock the terminal accommodated in a terminal accommodation chamber of a housing, the terminal extraction jig including:

a release pin configured to be inserted into the housing, abut against the locking portion, and cause the locking portion to displace in a locking release direction opposite to a locking direction of the terminal; and a guide pin that is provided below or above and in parallel with the release pin, and is configured to guide the release pin to the locking portion by being inserted into a groove portion formed in the housing.

(2) The terminal extraction jig according to (1), in which the release pin is formed at a tip end of a jig body gripped by an operator, and the guide pin is formed on an attachment mounted on the jig body.

(3) The terminal extraction jig according to the above (1), in which the guide pin has a protruding dimension smaller than that of the release pin.

(4) The terminal extraction jig according to the above [1], in which the release pin is guided to the locking portion by inserting the guide pin to the groove portion into which a hood portion of a mating housing fitted to the housing is inserted.

According to the terminal extraction jig having the configuration in the above (1), the guide pin, which is provided above or below and in parallel with the release pin, is inserted into the groove portion of the housing, whereby the release pin is guided to the locking portion. That is, even if the terminal extraction jig is inclined relative to the housing, a posture of the terminal extraction jig relative to the housing is corrected by the guide pin inserted into the groove portion of the housing. As a result, the release pin is inserted in a normal direction and guided to the locking portion. Therefore, the locking of the terminal can be smoothly and easily released by displacing the locking portion without causing the locking portion or the portion in the housing to be damaged or deformed by the release pin. In addition, the release pin is guided in the normal direction by the guide pin, so that it is not necessary to insert the release pin while carefully checking the release pin in the normal direction. Accordingly, the burden on the operator can be reduced, and the workability can be improved.

According to the terminal extraction jig having the configuration in the above (2), the guide pin can be easily disposed in parallel with the release pin by attaching the attachment to the jig body.

According to the terminal extraction jig having the configuration in the above (3), after the release pin is inserted into the housing, the guide pin is inserted into the groove portion of the housing to guide the release pin.

Therefore, the guide pin can be prevented from coming into contact with, for example, a member, a portion, or the like in the housing such as a seal member as much as possible, and damage to the housing can be prevented.

According to the terminal extraction jig having the configuration in the above (4), the guide of the release pin can be performed by using the groove portion into which the hood portion of the mating housing is inserted, so that it is possible to prevent an increase in cost due to the formation of the portion for the guide in the housing.

The present invention can provide a terminal extraction jig capable of smoothly and easily removing a terminal from a housing without damaging a locking portion or the like that locks the terminal.

The present invention is briefly described as above. Details of the present invention is further clarified by reading a mode for carrying out the invention (hereinafter, referred to as “embodiment”) described below with reference to attached drawings.

### BRIEF DESCRIPTION OF THE DRAWINGS

FIG. 1 is a perspective view of a terminal extraction jig according to the present embodiment.

FIG. 2 is an exploded perspective view of the terminal extraction jig according to the present embodiment.

FIG. 3 is a cross-sectional view taken along an axial direction of a tip end portion of the terminal extraction jig.

FIGS. 4A and 4B are views illustrating a guide pin. FIG. 4A is a plan view of the guide pin, and FIG. 4B is a side view of the guide pin.

FIG. 5 is a front view of a connector to which the terminal extraction jig is applied.

FIG. 6 is a cross-sectional view taken along a line A-A in FIG. 5.

FIG. 7 is a cross-sectional view taken along a line B-B in FIG. 5.

FIG. 8 is a cross-sectional view of a connector and a terminal extraction jig for showing a terminal extraction operation.

FIGS. 9A and 9B illustrate states of terminal extraction operations and are cross-sectional views of the connector and the terminal extraction jig, respectively.

FIGS. 10A and 10B illustrate states of terminal extraction operations by a terminal extraction jig having no guide pin. FIG. 10A is a cross-sectional view of a connector and a terminal extraction jig, and FIG. 10B is an enlarged view of a portion C in FIG. 10A.

### DETAILED DESCRIPTION OF EMBODIMENTS

A specific embodiment of the present invention is described with reference to drawings.

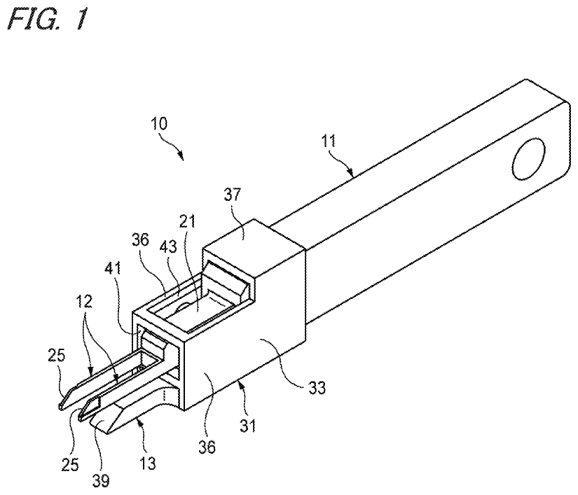

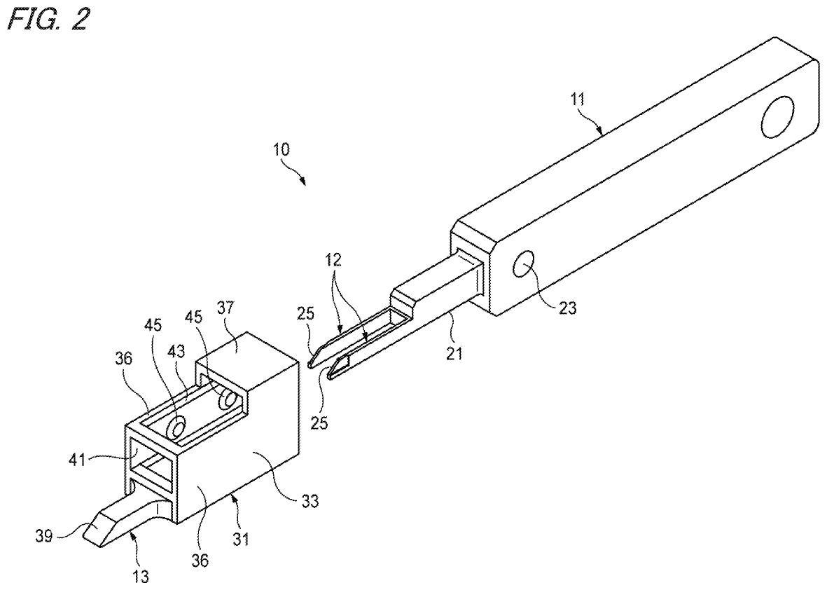

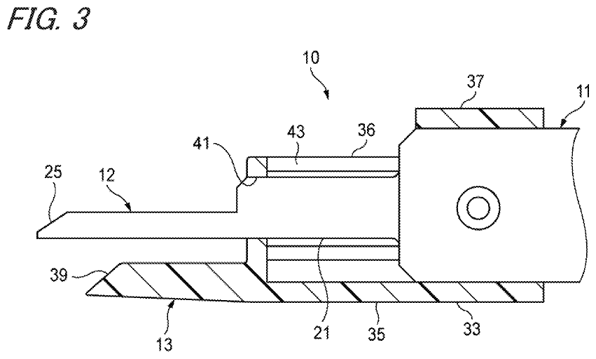

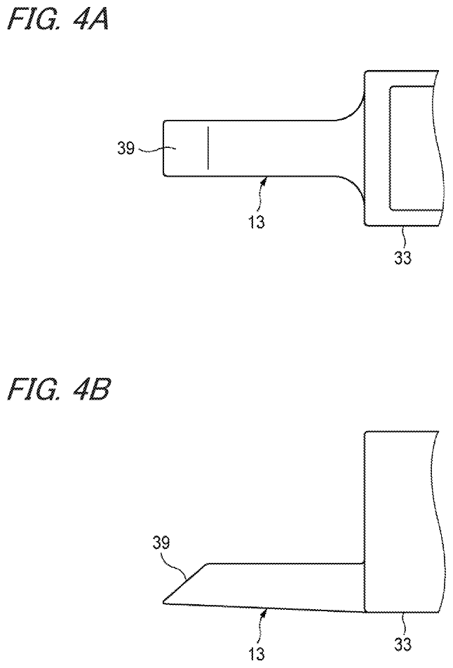

FIG. 1 is a perspective view of a terminal extraction jig 10 according to the present embodiment. FIG. 2 is an exploded perspective view of the terminal extraction jig 10 according to the present embodiment. FIG. 3 is a cross-sectional view taken along an axial direction of a tip end portion of the terminal extraction jig 10. FIGS. 4A and 4B are views illustrating a guide pin 13. FIG. 4A is a plan view of the guide pin 13, and FIG. 4B is a side view of the guide pin 13.

As shown in FIGS. 1 to 3, the terminal extraction jig 10 according to the present embodiment includes a jig body 11, a release pin 12, and the guide pin 13.

The jig body 1 is formed in a rod shape to be gripped by an operator, and has a rectangular shape in a cross-sectional view. A support rod portion 21 extending forward is formed at a tip end portion of the jig body 11. The support rod portion 21 has an outer shape smaller than that of the jig body 11 in a cross-sectional view. In addition, in the jig body 11, engagement recessed portions 23 are formed on two side surfaces in a vicinity of the tip end of the jig body 11.

The release pin 12 is formed at a tip end of the support rod portion 21. At the tip end of the support rod portion 21, a pair of release pins 12 are spaced apart from each other and extend forward in parallel with each other. The release pin 12 includes, at a tip end thereof, a pressing surface 25 that is an inclined surface. The pressing surface 25 is gradually inclined downward toward the tip end. A lower side and an upper side in the present embodiment correspond to a lower side and an upper side in FIGS. 1 to 3, FIG. 5, and the like.

The guide pin 13 is formed on an attachment 31. The attachment 31 includes a box-shaped mounting portion 33, and the guide pin 13 is formed at a lower portion of a tip end of the mounting portion 33. The mounting portion 33 includes a bottom plate portion 35, a pair of side plate portions 36, and an upper plate portion 37, and is formed in a rectangular shape in a cross section view.

The mounting portion 33 includes an opening at a rear portion thereof, and the jig body 11 is inserted from this opened rear portion. As a result, a periphery of the tip end portion including the support rod portion 21 of the jig body 11 is covered by the mounting portion 33 of the attachment 31.

The mounting portion 33 includes an opening portion 41 on a front side, and when the jig body 11 is inserted into the mounting portion 33, the release pin 12 provided on the support rod portion 21 of the jig body 11 protrudes from the opening portion 41. The upper plate portion 37 of the mounting portion 33 is cut out and the cutout portion serves as a window portion 43. Further, engagement protruding portions 45 that can be engaged with the engagement recessed portions 23 formed in the jig body 11 are formed on inner surface sides of two side plate portions 36 of the mounting portion 33. When these engagement protruding portions 45 are engaged with the engagement recessed portions 23, the attachment 31 is held at a predetermined position relative to the jig body 11.

As shown in FIGS. 4A and 4B, the guide pin 13 protrudes forward from the mounting portion 33. The guide pin 13 includes, at the tip end thereof, a guide surface 39 that is an inclined surface. The guide surface 39 is gradually inclined downward toward the tip end.

In the terminal extraction jig 10, the guide pin 13 is disposed below and in parallel with the release pin 12 by mounting the attachment 31 on the jig body 11. In this state, the guide pin 13 has a protruding dimension smaller than that of the release pin 12 and is disposed at a position where the tip end position thereof is retracted relative to the release pin 12.

Next, an example of a connector to which the terminal extraction jig 10 according to the embodiment having the above structure is applied will be described.

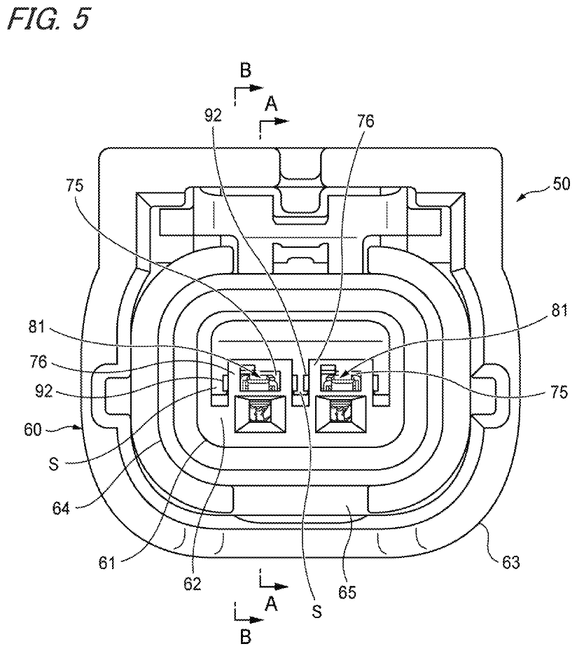

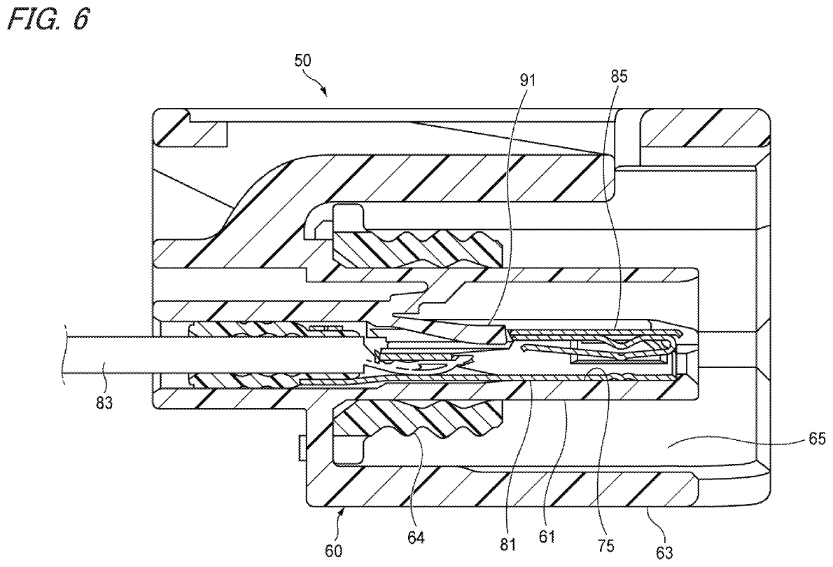

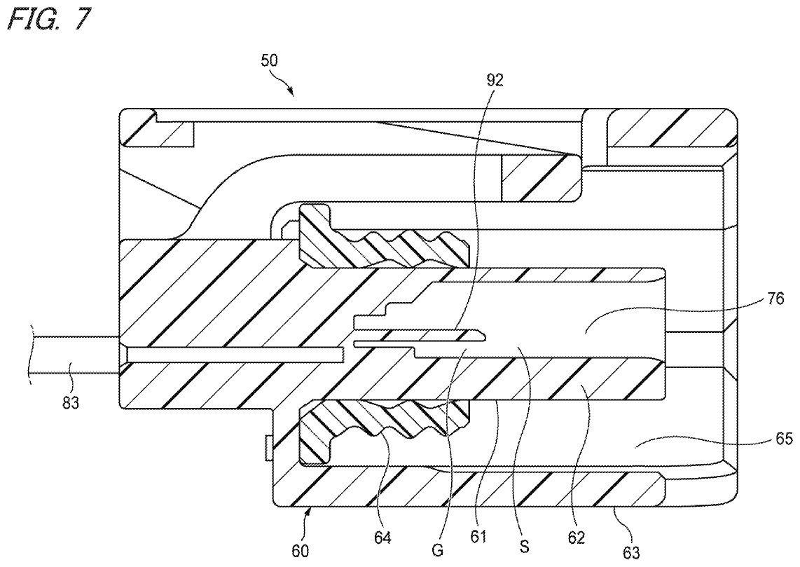

FIG. 5 is a front view of a connector 50 to which the terminal extraction jig 10 is applied. FIG. 6 is a cross-sectional view taken along a line A-A in FIG. 5. FIG. 7 is a cross-sectional view taken along a line B-B in FIG. 5.

As shown in FIGS. 5 and 6, the connector 50 includes a housing 60 that accommodates two female terminals (terminals) 81. The housing 60 is formed of a synthetic resin, and is formed by connecting an inner housing 61 with a cylindrical outer housing 63 surrounding the inner housing 61. A fitting groove (groove portion) 65 that is an annular gap is formed between the inner housing 61 and the outer housing 63, and a hood portion of a mating housing (not shown in the Figure) fitted to the housing 60 is inserted into the fitting groove 65. A seal member 64 is mounted on an outer peripheral surface of a root of the inner housing 61, and a fitting location between the housing 60 and the mating housing is sealed by inserting the hood portion into the fitting groove 65 and bringing the hood portion into close contact with the seal member 64.

Two terminal accommodation chambers 75 into which the female terminals 81 are inserted from a rear side are formed in the inner housing 61. In each terminal accommodation chamber 75, a tip end portion of the inner housing 61 is opened to the outside, and a tab-shaped male terminal (not shown in the Figure) provided in the mating housing is inserted from the tip end side.

The female terminal 81 inserted into the terminal accommodation chamber 75 and accommodated therein is connected to an end portion of an electrical wire 83. The female terminal 81 includes an electrical connection portion 85 that is electrically connected to the male terminal by inserting the male terminal and is formed in a rectangular tube shape.

The terminal accommodation chamber 75 is provided with a lance 91 on a rear end side thereof. A rear end side of the lance 91 is formed integrally with the inner housing 61, and a tip end side thereof extends toward the inside of the terminal accommodation chamber 75. The lance 91 locks the rear end of the rectangular tubular electrical connection portion 85 of the female terminal 81 accommodated in the terminal accommodation chamber 75. As a result, the female terminal 81 is prevented from coming off from the terminal accommodation chamber 75.

As shown in FIG. 7, a jig insertion space S is formed on a lateral side of the terminal accommodation chamber 75 in the inner housing 61 of the housing 60. On an outer surface of a side wall 76 forming the terminal accommodation chamber 75, a locking release piece 92 extending to the front side of the housing 60 is formed integrally with the lance 91. The locking release piece 92 is disposed in the jig insertion space S, and is formed with a gap G from a bottom wall 62 of the inner housing 61. A tip end position of the locking release piece 92 is slightly on the front side of the housing 60 relative to a tip end position of the seal member 64 mounted on the inner housing 61. In the housing 60, a locking portion is constituted by the lance 91 provided in the terminal accommodation chamber 75 and the locking release piece 92 disposed in the jig insertion space S and integrally formed with the lance 91.

Next, a description will be given of a case where the female terminal 81 accommodated in the terminal accommodation chamber 75 of the housing 60 of the connector 50 is removed by using the terminal extraction jig 10 according to the present embodiment.

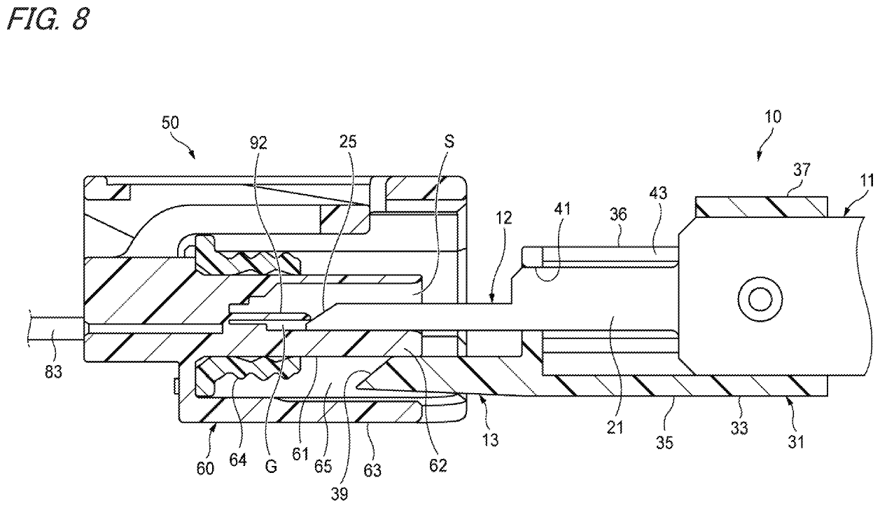

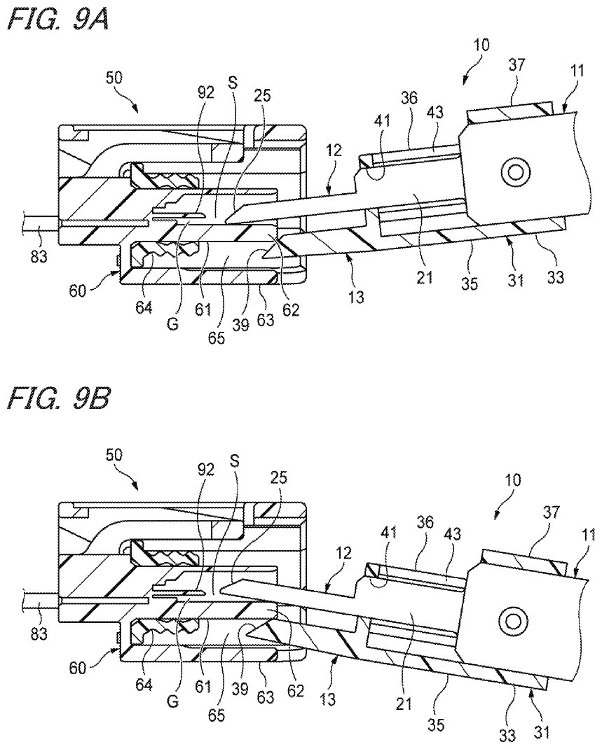

FIG. 8 is a cross-sectional view of the connector 50 and the terminal extraction jig 10 for showing a terminal extraction operation. FIGS. 9A and 9B illustrate states of terminal extraction operations and are cross-sectional views of the connector 50 and the terminal extraction jig 10, respectively.

First, the terminal extraction jig 10 is brought close to the housing 60 of the connector 50 from the front side. Then, the release pin 12 of the terminal extraction jig 10 is inserted into the jig insertion space S.

In this way, when the release pin 12 is inserted into the jig insertion space S, as shown in FIG. 8, the guide pin 13, which is provided below and in parallel with the release pin 12, is inserted into the fitting groove 65, which is a gap between the inner housing 61 and the outer housing 63. Then, in the housing 60 of the connector 50, the release pin 12 of the terminal extraction jig 10 is guided by the guide pin 13, and is inserted into the jig insertion space S, in a straight direction which is a normal direction, along an inner surface of the bottom wall 62 of the inner housing 61. As a result, a tip end of the release pin 12 enters the gap G between the bottom wall 62 of the inner housing 61 and the locking release piece 92, and the pressing surface 25, which is an inclined surface of the tip end of the release pin 12, abuts against an end portion of the locking release piece 92. Then, the locking release piece 92 is displaced in a manner of being pushed up along the pressing surface 25, and the lance 91 integrally formed with the locking release piece 92 is lifted toward the upper side which is a locking release direction, to release the locking of the electrical connection portion 85 of the female terminal 81. When the electrical wire 83 is pulled in a state where the locking of the electrical connection portion 85 of the female terminal 81 by the lance 91 is released, the female terminal 81 is pulled out from the terminal accommodation chamber 75.

When the release pin 12 of the terminal extraction jig 10 is inserted into the jig insertion space S formed in the housing 60 of the connector 50, the release pin 12 may be inserted into the jig insertion space S in an oblique direction different from the normal direction since the terminal extraction jig 10 is inclined relative to the housing 60. For example, as shown in FIG. 9A, the release pin 12 may be inserted into the jig insertion space S obliquely from above, or the release pin 12 may be inserted into the jig insertion space S obliquely from below, as shown in FIG. 9B.

As shown in FIG. 9A, when the release pin 12 is inserted into the jig insertion space S obliquely from above since the terminal extraction jig 10 is inclined relative to the housing 60, the guide surface 39 of the guide pin 13 enters the fitting groove 65 while being in contact with the bottom wall 62 of the inner housing 61. Then, the posture of the terminal extraction jig 10 inclined relative to the housing 60 is corrected, and thus the release pin 12 is guided in the straight direction which is the normal direction, and is inserted into the jig insertion space S.

Similarly, as shown in FIG. 9B, when the release pin 12 is inserted into the jig insertion space S obliquely from below since the terminal extraction jig 10 is inclined relative to the housing 60, the guide pin 13 enters the fitting groove 65 of the housing 60 while being in contact with the inner housing 61 and the outer housing 63. Then, the posture of the terminal extraction jig 10 inclined relative to the housing 60 is corrected. As a result, the release pin 12 is guided in the straight direction which is the normal direction and is inserted into the jig insertion space S.

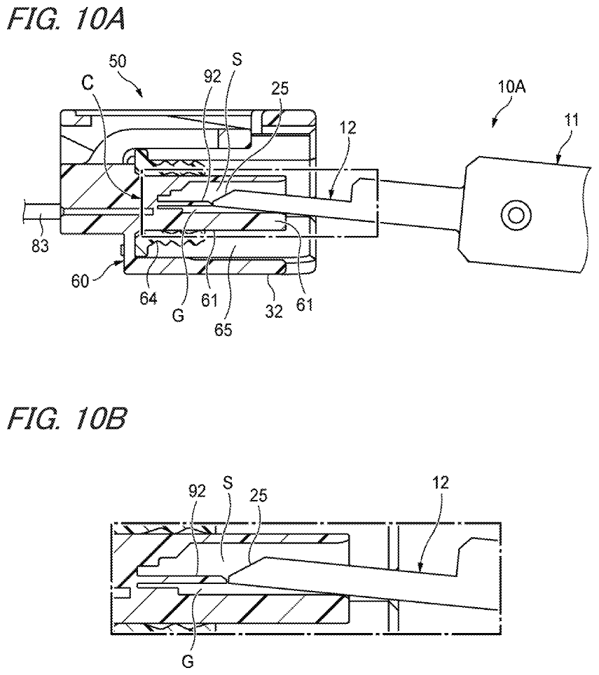

For example, as shown in FIG. 10A, in a terminal extraction jig 10A without the guide pin 13, the release pin 12 may be inserted obliquely into the back of the jig insertion space S since the terminal extraction jig 10A is inclined relative to the housing 60. Then, as shown in FIG. 10B, the tip end of the release pin 12 abuts against the end portion of the locking release piece 92, and thus the locking release piece 92 may be damaged or deformed. As a result, the housing 60 may not be used.

In contrast, according to the present embodiment, even if the terminal extraction jig 10 is inclined relative to the housing 60, the posture of the terminal extraction jig 10 relative to the housing 60 is corrected by the guide pin 13 inserted into the fitting groove 65 of the housing 60. As a result, the release pin 12 is inserted in the normal direction and guided to the locking release piece 92. Therefore, the locking of the female terminal 81 can be smoothly and easily released by displacing the lance 91 formed integrally with the locking release piece 92 without causing the locking release piece 92 or the portion in the housing 60 to be damaged or deformed by the release pin 12. In addition, the release pin 12 is guided in the normal direction by the guide pin 13, so that it is not necessary to insert the release pin 12 while carefully checking the release pin 12 in the normal direction. Accordingly, the burden on the operator can be reduced, and the workability can be improved.

Moreover, the guide pin 13 can be easily disposed in parallel with the release pin 12 by mounting the attachment 31 to the jig body 11.

After the release pin 12 is inserted into the housing 60, the guide pin 13 is inserted into the fitting groove 65 of the housing 60 to guide the release pin 12. Therefore, the guide pin 13 can be prevented from coming into contact with, for example, a member, a portion, or the like in the housing 60 such as the seal member 64 as much as possible, and damage to the housing 60 can be prevented.

Further, the guide of the release pin 12 can be performed by using the fitting groove 65 into which the hood portion of the mating housing is inserted, so that it is possible to prevent an increase in cost due to the formation of the portion for the guide in the housing 60.

The present invention is not limited to the above-described embodiment, and may be appropriately modified, improved, or the like. In addition, the material, the shape, the size, the number, the arrangement position or the like of each component in the above-described embodiment are optional and are not limited as long as the present invention can be achieved.

For example, in the above embodiment, the connector to which the terminal extraction jig 10 is applied is the connector 50 in which locking of the female terminal 81 by the lance 91 is released by displacing the locking release piece 92 provided integrally with the lance 91, and the connector is not limited to this example. For example, the above connector may be a connector in which locking of the female terminal may be released by directly displacing the lance by the release pin 12 of the terminal extraction jig 10.

The guide pin 13 is disposed below the release pin 12 in the above embodiment, and the guide pin 13 may be disposed above the release pin 12.

Here, features of the terminal extraction jig according to the embodiment of the present invention described above will be briefly summarized in the following [1] to [4].

[1] A terminal extraction jig (10) configured to release a locking state of a terminal (female terminal 81) caused by a locking portion (lance 91) configured to lock the terminal (female terminal 81) accommodated in a terminal accommodation chamber (75) of a housing (60), the terminal extraction jig including:

a release pin (12) configured to be inserted into the housing (60), abut against the locking portion (lance 91, locking release piece 92), and cause the locking portion to displace in a locking release direction opposite to a locking direction of the terminal (female terminal 81); and

a guide pin (13) that is provided below or above and in parallel with the release pin (12), and is configured to guide the release pin (12) to the locking portion (lance 91, locking release piece 92) by being inserted into a groove portion (fitting groove 65) formed in the housing (60).

[2] The terminal extraction jig according to [1],

in which the release pin (12) is formed at a tip end of a jig body (11) gripped by an operator, and

the guide pin (13) is formed on an attachment (31) mounted on the jig body (11).

[3] The terminal extraction jig according to the above [1], in which the guide pin (13) has a protruding dimension smaller than that of the release pin (12).

[4] The terminal extraction jig according to the above [1], in which the release pin (12) is guided to the locking portion (lance 91, locking release piece 92) by inserting the guide pin (13) to the groove portion (fitting groove 65) into which a hood portion of a mating housing fitted to the housing (60) is inserted.

What is claimed is:

1. A terminal extraction jig configured to release a locking state of a terminal caused by a locking portion configured to lock the terminal accommodated in a terminal accommodation chamber of a housing, the terminal extraction jig including:
a release pin configured to be inserted into the housing, abut against the locking portion, and cause the locking portion to displace in a locking release direction opposite to a locking direction of the terminal; and
a guide pin that is provided below or above and in parallel with the release pin, and is configured to guide the release pin to the locking portion by being inserted into a groove portion formed in the housing.

2. The terminal extraction jig according to claim 1,
in which the release pin is formed at a tip end of a jig body gripped by an operator, and
the guide pin is formed on an attachment mounted on the jig body.

3. The terminal extraction jig according to claim 1, in which the guide pin has a protruding dimension smaller than that of the release pin.

4. The terminal extraction jig according to claim 1, in which the release pin is guided to the locking portion by inserting the guide pin to the groove portion into which a hood portion of a mating housing fitted to the housing is inserted.
